(19) United States
(12) Patent Application Publication
(10) Pub. No.: US 2006/0112219 A1
(43) Pub. Date: May 25, 2006

(54) Functional partitioning method for providing modular data storage systems

(76) Inventors: Gaurav Chawla, Santa Clara, CA (US); Rodney Dekoning, Santa Clara, CA (US); Kevin J. Clarke, Santa Clara, CA (US)

Correspondence Address: HOGAN & HARTSON LLP, ONE TABOR CENTER, SUITE 1500, 1200 SEVENTEEN ST., DENVER, CO, 80202, US

(21) Appl. No.: 10/993,182

(22) Filed: Nov. 19, 2004

(51) Int. Cl. G06F 12/16

(52) U.S. Cl. 711/114; 711/115

(57) ABSTRACT

A modular data storage system with a control path and a data path. The storage system includes three modular components linked and adapted for independent removal and insertion within the modular data storage system. A service processor is positioned in the control path, a data services platform is positioned in the data path and the control path, and a storage array controller is positioned in the data path and the control path. The data services platform has a host interface interfacing with storage application hosts and includes a control path block linked to the service processor. The platform includes a data path block including data path functions that may be functions partitioned for performance only by the data services platform. The storage array controller includes a control path block linked to the service processor and including control interfaces. The controller includes a data path block including data path functions.

### BACKGROUND OF THE INVENTION

1. Field of the Invention

The present invention relates, in general, to data storage systems and data storage processes, and, more particularly, to a method, and systems configured according to the method, of partitioning data storage functions into two or more data storage system components to provide a modular data storage system in which the separate modules can be replaced or modified without replacing or modifying other modular components. The present invention also allows each of the data storage components to be scaled independently of other components based on user requirements (e.g., business application requirements) for scaling storage functions.

2. Relevant Background

Efficient, secure, and cost effective data storage continues to grow in importance worldwide. Storage systems can be classified by their price ranges with a common classification lower cost systems being labeled workgroup storage systems, intermediate cost products being labeled midrange and/or enterprise storage systems, and higher cost systems being labeled data center storage systems. Often, the midrange storage systems will include at least some lower end and some higher end components. As the importance of data storage increases, customers or users of data storage continue to demand higher functionality in the workgroup and midrange data storage systems and to demand more control over and flexibility of changing such data storage functionality. As a result, the computer industry is faced with the challenge of how to facilitate development of improved workgroup and midrange storage systems that are able to deliver a wider range of functions while increasing customer control and system effectiveness, security, and flexibility but lowering or controlling costs.

For example, the storage market demands that midrange or enterprise storage systems are adapted for advanced functionality. The advanced features and functions being demanded include increased control path administration functionality and data path functionality, e.g., improved functionality on both the control and data processing storage sides of the storage system. Providing enhanced functionality and scalability is an even bigger challenge for the storage system designer and distributor due to the waterfall trend of providing data center storage system functionality in midrange or enterprise storage systems and midrange functionality at the workgroup level. Hence, over time, storage systems need to be able to add and change their functionality to meet customer demands.

Unfortunately, existing data storage systems are designed and configured as monolithic or unitary storage devices. The present unitary design of storage systems makes it difficult to add or modify existing features and functions, and it often requires a high level of engineering investment to maintain the software or code base of the storage system and to provide ongoing maintenance of its software and hardware.

Hence, there remains a need for an improved data storage system that better supports ongoing or gradual enhancement and addition of functionality to the data storage system. Preferably such system and method would be configured to allow data storage systems to be designed and distributed with varying functionality and configurations to meet the needs of particular storage users, such as to meet needs of cost, security, and data path functionality.

### SUMMARY OF THE INVENTION

The present invention addresses the above and other problems by providing a modular data storage system that is configured with partitioned functions, such as midrange, enterprise, and/or data center storage system functionality. The modular data storage system includes modular building blocks or storage subsystems with functional partitioning defined within and across these subsystems and with the role of each subsystem well established to provide the overall desired functionality of the modular data storage system. Due to the functionality partitioning and resulting modularity, each of the components or subsystems can be developed and enhanced in parallel and independently to meet the demand for advances in storage system functionality in the overall integrated storage system.

In one embodiment of the invention, the modular data storage system includes three subsystems or components that are labeled a data services platform (DSP), a storage array controller (SAC) or storage array, and a service processor (SP). During operation, the three modular components act in conjunction as a unit to provide the desired (such as by the storage user, the enterprise, or the like) functionality in both the control path and data path portions or blocks of the modular data storage system, e.g., data services functionality, RAID (redundant array of inexpensive disks) functionality, caching functionality, and other data storage functionalities. Briefly, the DSP provides the front end data path interfaces from the modular storage system and connects to the data storage (e.g., storage arrays) via the SAC to provide a persistent data store. The DSP also connects to the SP to provide administrative interfaces for the modular storage system. The SAC (and connected data storage devices) is responsible for managing all drive interfaces and for providing a persistent data store functionality to the DSP, such as by providing RAID and caching functions and managing drive failures, spare drive management, and the like. The SAC also connects to the SP to provide an administrative interface to the data storage components of the modular data storage system. The SP provides external interfaces for connecting the modular data storage system to an external network, such as to a customer's or enterprise's data management host or network. The SP also provides the administration interfaces for the control path portion of the modular system including management interfaces, diagnostics, remote monitoring, software distribution, time management, and management APIs (Application Programming Interfaces). Other storage system functions, such as data path boot up sequencing, network time management, syslog interfaces, and core file management, may also be provided and the partitioning of all or portions of these additional functions is used to define the responsibilities and functionality of each of the three components of the modular data storage system of the present invention.

More particularly, a modular data storage system is provided with a control path and a data path. The storage system is adapted for managing a storage device, such as one or more arrays of disks, and for communicating with a storage management device or network in the control path and with one or more storage application hosts in the data path. The storage system includes three modules or components that are communicatively linked and that are adapted for independent removal and insertion within the modular data storage system, which facilitates parallel development and separate upgrading and modification of the modular components. The components are a service processor positioned in the control path, a data services platform positioned in both the data path and the control path, and a storage array controller positioned in both the data path and the control path. The service processor includes an external management interface for interfacing with the storage management device and a control path block with a set of control path functions partitioned for performance by the service processor.

The data services platform has a host interface for interfacing with the storage application hosts. The platform further includes a control path block in the control path linked to the control path block of the service processor and including one or more control interfaces. The platform also includes a data path block positioned in the data path including a set of data path functions. A portion of these data path functions are functions partitioned within the modular data storage system for performance only by the data services platform and these may include functionalities such as virtualization, backup, snapshots, remote mirroring, hierarchical storage management (HSM), and power management for the platform. The storage array controller includes a control path block positioned in control path linked to the control path block of the service processor and including control interfaces. A drive interface is included in the storage array controller for communicating and interfacing with the storage device(s). The storage array controller includes a data path block positioned in the data path and including a set of data path functions. These controller data path functions include a set of functionalities that are partitioned within the modular data storage system for performance only by the controller, and these partitioned functions may include RAID functionalities, caching functionalities, and the like. Within the sets of data path functions in the data services platform and in the storage array controller, a set of end-to-end functionalities are included that require the two modular components to function collaboratively to provide host-to-storage functions such as optimization functions, data integrity functions, RAS functions, SLA/QoS functions, and other similar functionalities.

### BRIEF DESCRIPTION OF THE DRAWINGS

FIG. 1 illustrates in block form an exemplary computer network including a storage system, such as a midrange or enterprise system, with modular components configured according to the present invention using partitioned control and data path functionality;

FIG. 2 is a block diagram illustrating details of a modular data storage system that may be used in a system such as that shown in FIG. 1 and that shows exemplary partitioning of data storage functionality among a service processor, a data services platform, and one or more storage array controllers (or arrays); and

FIG. 3 illustrates an exemplary process for creating and updating a modular data storage system according to the present invention.

### DETAILED DESCRIPTION OF THE PREFERRED EMBODIMENTS

The present invention is directed to a modular data storage system that utilizes a partitioning method to assign and divide data storage functionality among two or more components or storage subsystems. When installed and integrated, the modular data storage system uses two or more components that each deliver a specific role with well defined functionality to provide demanded functions and access to a data store, such as a server-based storage system including disk arrays. In some cases, a storage developer is able to define partitioning of various storage system functions, to create the various modular components independently and/or in parallel, and then, based on requirements or needs of an enterprise or customer, to combine two or more of the modular storage system components to create a modular data storage system that can be installed as an integrated unit. The modular design allows parallel development of components which facilitates development, function and component integration, and storage product delivery, maintenance, and upgrading.

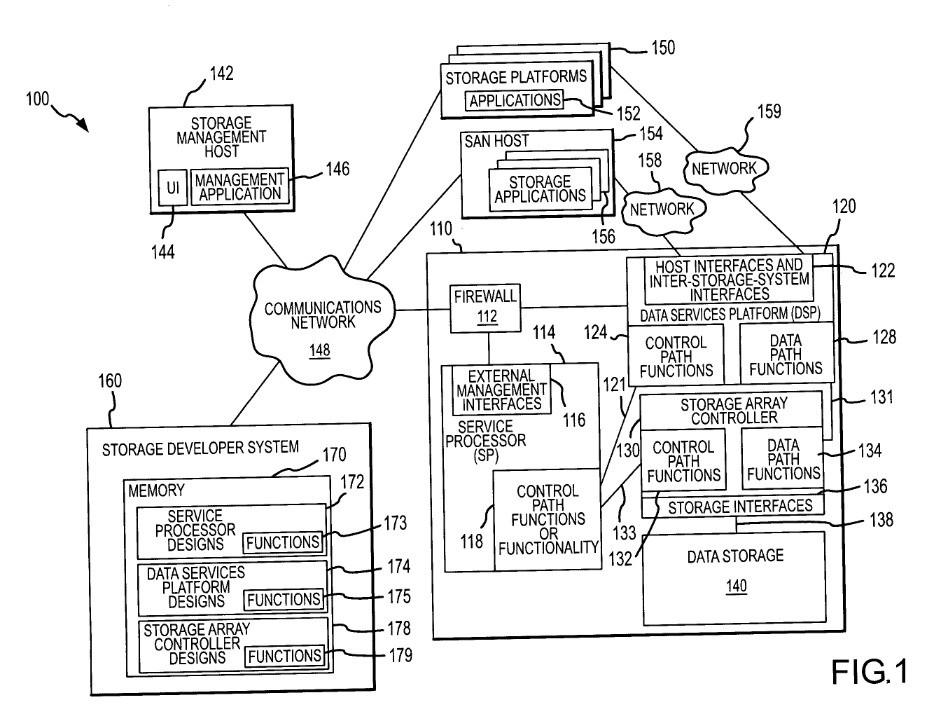

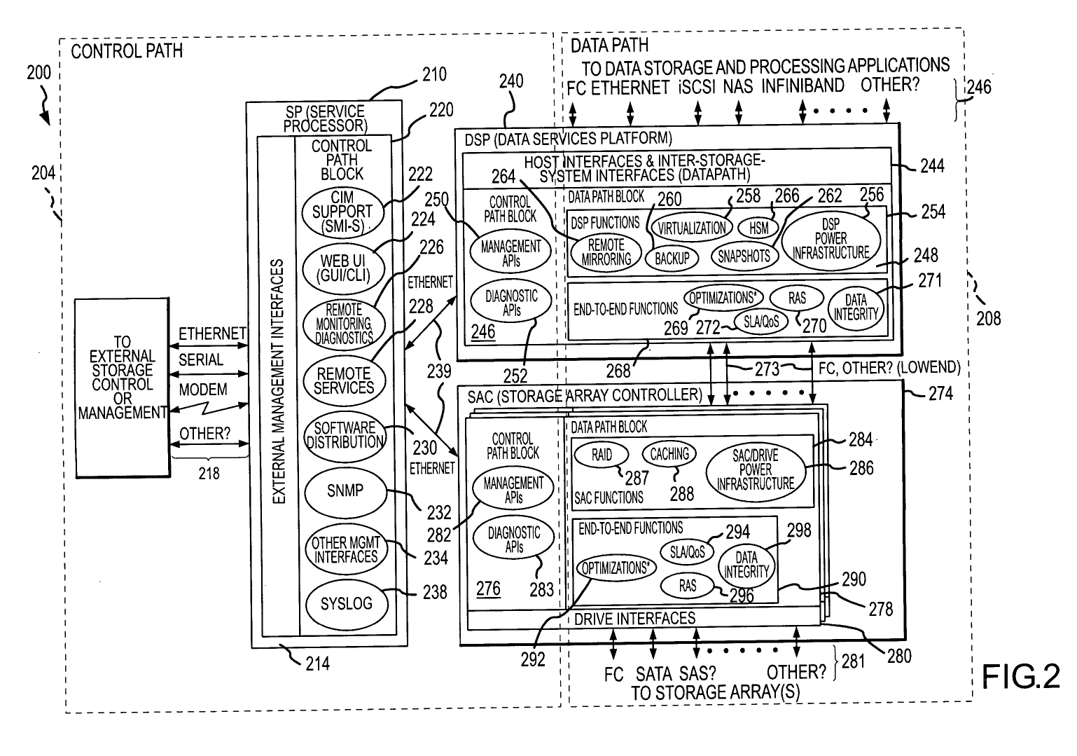

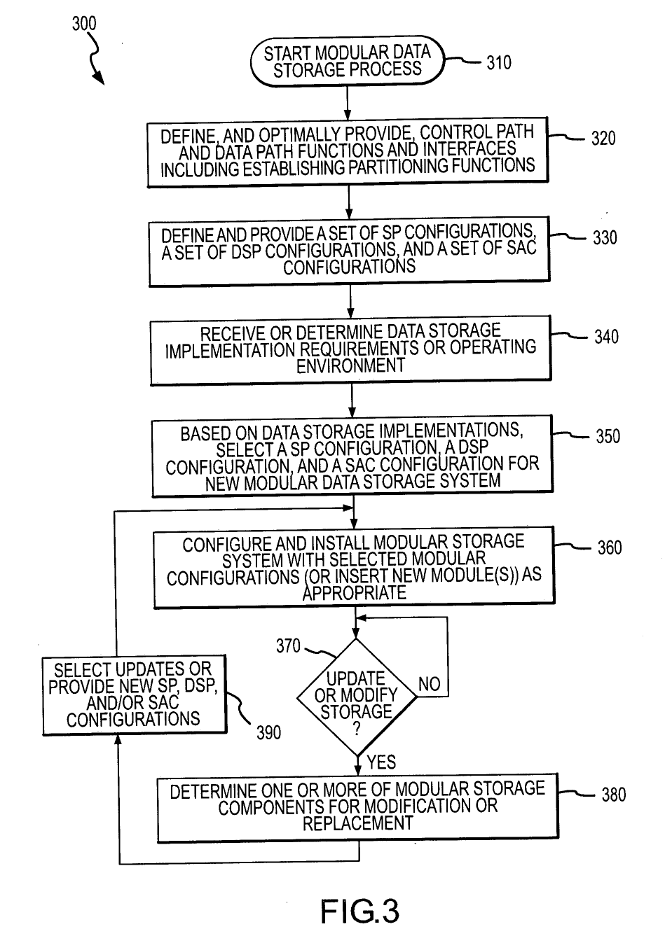

With reference to FIG. 1, the following description begins with a discussion of a computer network in which a customer or enterprise data storage system including a modular data storage system according to the present invention. FIG. 2 is then used to more fully describe the partitioning of control and data path functionality among three storage system modules or components. As shown and will become clear, one embodiment of the modular data storage system provides a set of data process features or functions with three distinct building blocks or modules including a data services platform (DSP), a storage array controller (SAC or Array), and a service processor (SP). The modular data storage system shown in FIG. 2 is typically configured to allow for delivery of storage systems that are agnostic of host platform operating systems, and the modular architecture of the storage system delivers all the data and control path features in an integrated, seamless fashion, i.e., there is typically no need to install additional management software or other modules on the associated customer hosts to administer the modular data storage system (but, generally host bus adapters and drivers may need to be installed on the customer hosts to provide SAN and storage system connectivity). However, in some cases, administration functionality is not provided in the modular system and these administrative functions are host based (e.g., the modular system may only include the data services platform (DSP) and a storage array controller (SAC) or a storage array). The description then describes a modular data storage process with reference to FIG. 3. After this description of the functionality partitioning aspect of the invention with reference to FIGS. 1-3, the following description proceeds to provide a more detailed discussion of some exemplary functions or functionalities that may be defined for a modular data storage system and how the partitioning may be accomplished according to the invention.

In the following discussion, computer, network, and storage devices, such as the software and hardware devices within the systems 100 and 200, are described in relation to their function rather than as being limited to particular electronic devices and computer architectures and programming languages. To practice the invention, the computer and network devices and storage devices may be any devices useful for providing the described functions, including well-known data processing and communication devices and systems, such as application, database, web, and entry level servers, midframe, midrange, and high-end servers, personal computers and computing devices including mobile computing and electronic devices with processing, memory, and input/output components and running code or programs in any useful programming language, and server devices configured to maintain and then transmit digital data over a wired or wireless communications network. Data storage systems and components are described herein generally and are intended to refer to nearly any device and media useful for storing digital data such as tape-based devices and disk-based devices, their controllers or control systems, and any associated software. Data, including transmissions to and from the elements of the network 100 and system 200 and among other components of the network 100 and system 200, typically is communicated in digital format following standard communication and transfer protocols, such as TCP/IP, HTTP, HTTPS, FTP, and the like, or IP or non-IP wireless communication protocols such as TCP/IP and the like.

FIG. 1 illustrates a simplified computer network or system 100 that incorporates the features of the invention. The system 100 includes a modular data storage system 110 that is in communication with a storage management host and a storage developer system 160 via a communications network 148, such as the Internet, an IP network, a LAN, or any other useful digital data communications network. The storage management host 142 runs a user interface 144 for allowing an administrator to administrate storage via a GUI or command line interface and runs a management application 146 for interfacing with the storage system 110 (such as with data services platform 120 and/or services processor 114). When a user chooses to run the management application 146, it interacts with services processor 114 using well-defined management interfaces exported by services processor 114, such as CIM, SMI-S, SNMP, and the like. The system 100 further includes one or more hosts that store and access data in the modular data storage system 110 and are linked via communications network 148, such as for control communications, and via local networks 158, 159 (e.g., Fibre Channel (FC), Ethernet, or other links/networks such as Infiniband, NAS, iSCSI, and the like), such as for data path communications. For example, as shown, a storage platform(s) or multiplatform host(s) 150 running applications 152 may access the storage system 110 via local network 159 and via communications network 148, and a SAN (or other) host(s) 154 running one or more storage applications 156 may access the storage system 110 via local network 158 and communications network 148.

The storage system 110 is modular with well-defined and partitioned functions performed by each module or working block. As is discussed below with reference to FIG. 3, this allows parallel and independent development and upgrading of the storage system modules and allows the storage system 110 to be created using varying module designs and collections of such varying modules. For example, a storage array controller may be selected from a set of such controllers, with each being designed to perform different partitioned functions, for use with a data services platform and a service processor, e.g., a different functionality may be provided by selecting a different module. With this in mind, the storage developer system 160 is shown to include memory 170 storing a set of service processor designs 172 with a set of defined functions 173, a set of data services platform designs 174 with a set of defined functions 175, and a set of storage array controller designs 178 with a set of defined functions 179. With some limitations, these designs 172, 174, 178 can be mixed and matched to generate numerous modular data storage system designs, which can in turn be used to configure the modules or building blocks of the system 110 to provide a system 110 with desired functionality (such as storage system processes and features demanded or requested by a customer operating the storage platform 150 and/or the SAN host 154). In some cases, the designs 172, 174, 178 and/or functions 173, 175, 179 may be used to directly, such as over network 148, modify or initially configure a system 110, but more typically, the designs 172, 174, 178 are selected and then used to configure components of storage system 110 prior to its delivery and installation at a customer site.

According to an important aspect of the invention, the system 110 is not monolithic but is instead comprises a number of modular components across which the functions of the system 110 are assigned and partitioned. The system 110 includes a firewall 112 to provide secure communications with network 148. More significantly, the system 110 has three modular building blocks including a service processor (SP) 114, data services platform (DSP) 120, and a storage array controller (SAC) 130 that is linked via link(s) 138 to a data storage 140 (such one or more arrays of disks). Generally, as shown, the SP 114 includes external management interfaces 116 and control path functions or functionality 118 is in communication over links 121 and 133 with the DSP 120 and the SAC 130, respectively. The DSP 120 also includes control path functions 124 and is in communication with the SP and the hosts 142, 150, 154 over the network 148 and via firewall 112. Additionally, the DSP 120 is positioned in the data path of the network 100 and includes host interfaces and inter-storage-system interfaces 122 linked to hosts 150, 154 via local networks 158, 159. The DSP 120 also includes a set of data path functions 128 and is in communication via link 131 with the SAC 130. The SAC 130 includes storage interfaces 136 for communicating with data storage 140 via link(s) 138. The SAC 130 also includes a set of control path functions 132 and a set of data path functions 134. As will become clear from discussion of FIG. 2, the modular architecture of the system 110 allows the modular components 114, 120, 130 to be replaced independently and/or for the interfaces and/or functions 116, 118, 122, 124, 128, 132, 134, 136 to be deleted, replaced with newer versions, or otherwise modified in parallel without necessarily requiring modification of the other modules and their functions or interfaces.

As shown, each of the subsystems or modules 114, 120, 130 provides a defined set of functionalities and interact with each other and the external world using a set of defined set of interfaces. Both the DSP 120 and the SAC 130 include a data path functional block 128, 134 and a control path functional block 124, 132 that provide highly available connectivity for both paths and in some cases, these blocks reside in separate failure domains to meet system RAS requirements. The DSP control path 124 and the SAC control path 132 connect to the SP control path 118, which provides control path interfaces 116 to the external world from the perspective of the storage system 110. The architecture of system 110 allows for delivery of a low end product with customer host resident service processor functionality, i.e., the SP 114 can be eliminated or provided with lower functionality 116, 118 with all or most of the SP functions being performed by the management application 146 on storage management host 142.

In most embodiments, the configuration of the data path with the partitioned functions 128, 134 on the modules 120, 130 as shown in FIG. 1 provides support for data access (data store and retrieve) features such as virtualization, snapshots, remote replication, RAID, caching, data migration, data integrity assurance, and other data services. Similarly, the configuration of the control path with the partitioned functions 116, 118, 124, 132 on modules 114, 120, 130 provides support for administration features such to be implemented by the system 110 such as configuration management, diagnostics, fault management, fault mitigation, remote monitoring, software distribution, remote serviceability, and other control functions. Typically, some of the functions of the storage system 110 are completely owned or partitioned by one of the subsystems 114, 120, 130 while other functions are provided with an end-to-end implementation on the control path or data path which requires partitioning of functions across the modules 114, 120, 130. For example, data path end-to-end implementations involve the DSP 120 and the SAC 130 implementing data path functions 128, 134 with well defined functionality designed to interact with each other using defined interfaces as appropriate.

FIG. 2 illustrates a modular data storage system 200, such as may be used within system 100 of FIG. 1. The storage system 200 is constructed with three modules or building blocks including a service processor 210, a data services platform 240, and a storage array controller 274. As shown, the storage system 200 can be divided into a control path portion 204 and a data path portion 208. The service processor 210 is positioned in the control path 204 and includes external management interfaces 214 for communicating with an external storage control or management application(s) via communication link 218 (e.g., Ethernet, serial, modem, or other communication link(s)). The service processor 210 further includes a control path block 220 with a set of control path functions, i.e., functionality assigned or partitioned to the service processor 210, which as shown may include the following interfaces and/or functionalities: CIM support 222, Web UI 224, remote monitoring 226, remote service 228, software distribution 230, SNMP 232, Syslog 238, and/or other management interfaces. In some embodiments, a greater or lesser number of functions are provided in the control path block 220 of the service processor 210.

As shown, the data services platform 240 and the storage array controller 274 include control path blocks 246, 276 that are positioned within the control path 204 of the modular system 200 and that communicate with the control path block 220 of the service processor 210 over links 239, which are shown as Ethernet links but other links may be utilized to practice the invention. The control path blocks 246, 276 include interfaces to facilitate communications and standardized connection with the service processor 210 which allows the modular components 210, 240, 274 to be plugged and unplugged from the system 200 independently. As shown, the control path blocks 246, 276 includes management APIs (application programming interfaces) 250, 282 and diagnostics APIs 252, 283.

The data service platform 240 and the storage array controller 274 are also both positioned within the data path 208 of the system 200. In this regard, the data services platform 240 is positioned in the data path 208 so as to interface with data storage and data processing applications (not shown) such as those running on local hosts and to interface with the storage array controller 274. To communicate with host applications, the data services platform 240 includes host interfaces and inter-storage-system interfaces 244 and is in communication over link or links 242, such as FC, Ethernet, iSCSI, NAS, Infiniband, or other communication links, with the host applications. Links 273, e.g., FC and the like, are used to link the data services platform 240 with the storage array controller 274 in the data path 208.

Within the data path block 248, the data services platform 240 includes sets of defined functionalities that are partitioned to the platform 240. In the embodiment shown, the partitioned functions are divided into a set of DSP functions 254 that are handled by or belong entirely to the platform 240 (i.e., are performed by the platform 240) and a set of end-to-end functions 268 that require at least some interaction and/or assistance by corresponding functions on the storage array controller 274. The functionalities included in each of these partitioned sets may vary widely to practice the invention and can be mixed and matched to create a data services platform 240 and system 200 that meets the needs/demands of a user or an enterprise. The specific functionality of the platform 240 is discussed below and as shown, includes virtualization 258, backup 260, snapshots 262, remote mirroring 264, and hierarchical storage management (HSM) 266 in the DSP functions 254 and includes optimizations 269, Reliability Availability Serviceability (RAS) 270, data integrity 271, and SLA/QoS 272 in the end-to-end functions 268.

Likewise, in the data path block 278, the storage array controller 274 includes sets of defined functions or functionalities that are assigned to or partitioned within the controller 274. As shown, the partitioned functions include a set of SAC functions 284 that are performed solely by the controller 274 and, as shown, include drive power infrastructure 286, RAID 287, and caching 288. Again, more or less functionality may be partitioned to the controller 274. A set of end-to-end functions 290 are also provided to work with the data services platform 240 and include optimizations 292, SLA/QoS 294, RAS 296, and data integrity 298. The storage array controller(s) 274 also provides the interface for the modular system 200 with data storage devices or storage arrays, and as such, the controller 274 includes drive interfaces 280 linking the controller 274 via links 281 (e.g., FC, SATA, SAS, and the like) with a storage array or arrays (not shown).

To build on the above explanation of the modular components, the following discussion provides a more detailed discussion of each of the three components 210, 240, 270 used in modular system 200 to provide desired functionality for a storage implementation (such as a midrange, enterprise, or data center implementation). As noted earlier, the DSP 240 includes a data path functional block 254 and a control path functional block 246. The DSP 240 is generally responsible for providing data path connectivity to the external world and providing control path connectivity to the SP 210. The modular architecture is useful because the DSP 240 does not connect directly to disk drives or other storage devices and as a result, the DSP 240 does not have to evolve with the evolution of the drive interconnects and drive technologies. Instead, the DSP 240 connects to the array or storage array controller 274 using well-defined hardware and software interfaces. The I/O performance of the DSP 240 and the array controller 274 preferably scales such that they do not introduce performance bottlenecks in the data flow path 208.

The data path functions 254, 268 and interfaces 244 in the DSP 240 are selected to provide a set of desired functionalities. While these may vary, the illustrated DSP 240 supports host/SAN connectivity and includes interfaces 244 to meet its responsibility of supporting host interfaces and protocols to meet the host, SAN, and other connectivity requirements. The DSP 240 also functions to provide interfaces to connect to one or more storage array controllers 274. This interface is internal to the DSP 240 and is not visible to the customer or user administrator, and is selected based on the product scalability/cost criteria. In one embodiment, FC is used for the interface/link 273. The data path portion of the DSP 240 also supports advanced virtualization features with functionality 258 to allow for virtualization across virtual disks exported by multiple back end arrays. The DSP data path block 248 also supports a number of data services features including snapshots 262, data migration, backup 260, HSM 266, remote monitoring 264, remote replication and other features to meet customer availability and storage system feature requirements.

The functions in the data path block 248 may be selected to support inband interstorage system interfaces to deliver disaster recovery oriented data services features such as remote mirroring 264 and remote replication. The data path block functions 248 may further support data path boot up sequencing. For example, to provide higher availability, the data path 208 may be designed to not depend on the control path 204 from the availability perspective and vice versa. In this case, at storage system 200 boot up, the DSP 240 ensures that all the configured and online arrays are up and running and all the backend virtual disks are accessible prior to exporting virtual volumes to SAN or other hosts. If configured and online virtual disks are not available in a defined maximum time interval, then these virtual disks are changed to offline or degraded depending on the priorities of the virtual volume and then, these virtual volumes can be exported to the SAN hosts.

The control path block 246 of the DSP 240 has its own separate or partitioned functions. The control path block 246 provides management APIs 250 that can be used by the service processor 210 to administer the DSP 240. These APIs 250 preferably allow for configuration management, fault/event reporting, software distribution (e.g., firm wide updates), and similar aspects of the DSP 240. The control path block 246 preferably also allows for taking firmware core dump files from the perspective of troubleshooting and fault management. The control path block 246 further provides diagnostics APIs 252 to allow the service processor 210 to perform online (runtime) and offline diagnostics and to run online/offline exercisers. This allows the service processor 210 and service personnel to perform early fault detection, verify FRU behaviors, and perform fault isolation to a single FRU. The control path block 246 may also be configured to manage the power infrastructure of the DSP 240 and allow the service processor 210 to control DSP power management.

The storage array controller (SAC) 274 also includes a data path block 278 and a control path block 276. The SAC 274 interfaces with disk drives and expansion trays and other components of the storage array or data store. The SAC 274 does not connect directly with devices external to the system 200, and it connects to a DSP 240 for data path 208 interfaces, which provides the connectivity to customer hosts and customer SAN(s) and connects to the service processor (SP) 210 for control path 204 connectivity to the external world, such as a customer's management network and applications. Data path 208 interactions with the DSP 240 and control path 204 interactions with the SP use well-defined hardware and software interfaces, such as FC for the data connection 273 with the DSP 240 and Ethernet for the control path connection 239 with the SP 210. The I/O performance of the DSP 240 and SAC 274 (and controlled array) preferably scales such that it does not introduce performance bottlenecks in the data flow path 208.

The data path block 278 of the SAC 274 supports various disk drive interfaces, drive protocols, and drive technologies 280. The disk drives (not shown) in some embodiments are an integral part of the SAC 274 with the modular component considered an “array” or “storage component” 274. The SAC 274 is responsible for managing the drive density with element 280 and for ensuring appropriate data layout, such as with RAID functionality 287 in SAC functions 284 and/or with RAS functionality 298 in end-to-end functions 290. The data path block 278 provides interfaces to connect with the DSP 240. This interface is internal to the storage system 200 and is typically not visible to an operator of the system 200, e.g., a customer. The interface is selected based on the product scalability/cost criteria and in some embodiments, the interconnect 273 is FC-based. In other embodiments, the interconnect is not FC and uses one or more other communication protocols/technologies. Additionally, the invention is not limited to a specific class of drive and can be used with numerous drive classes such as SATA (serial ATA) drives and the like. The data path block 278 further delivers RAID functionality 287 to allow for creation of RAID levels to meet customer requirements, such as RAS requirements which are also met with RAS functionality 296, and to utilize associated disk drive capacities. The data path block 278 also delivers data caching functionality 288 to provide caching features for the storage system 200. Caching 288 can be internally implemented as a single level caching strategy or as a multi level caching strategy. The data path block 278 may also provide battery backup support 286 to allow for a non-volatile data cache via caching 288.

The SAC control path 276 provides a number of partitioned functionalities including providing management APIs 282 that can be used by the service processor 210 to administer the storage array(s) via drive interfaces 280 and interconnect 281. The management APIs 282 preferably allow for configuration management, fault/event reporting, software distribution (firmware updates and the like) aspects of the storage array(s). The management APIs also typically allow for taking firmware core dump files from the perspective of troubleshooting and fault management. The SAC control path 276 also provides diagnostics APIs 283 to allow the service processor 210 to perform online (runtime) and offline diagnostics and to run online/offline exercisers. This allows the service processor 210 and service personnel to perform early fault detection, to verify FRU behaviors, and to perform fault isolation to a single FRU. The control path block 276 may also manage the power infrastructure of the SAC 274 and storage array(s) and allow the service processor 210 to control power management for the SAC 274 and corresponding storage array(s).

The service processor module (SP) 210 manages the overall functionality of the control path 204 and provides all the external interfaces for out of band administrative interfaces and for connecting the storage system 200 with a customer's management network such as via interconnect 218. The SP 210 provides support for control path 204 connectivity to a customer's management network, such as via an Ethernet connection, and interfaces 214 (which may include management, remote monitoring, diagnostics, and/or software distribution interfaces that can be utilized without requiring a customer to login to the SP 210, e.g., a browser-based UI and remote scriptable command line interface 224 with the UI typically being resident on the SP 210 but allowing for a browser to connect via 218 to SP 210 via a secured web or other network connection). The SP 210 provides support for software interfaces 222, 232 compliant with the SMI-S CIM interfaces and SNMP interfaces.

The control path block 220 further supports time management from the storage system perspective and typically, provides support for NTP (Network Time Protocol), such as with the SP 210 being the NTP client for an external NTP server (not shown) and with the SP 210 serving as the NTP server for the DSP 240 and SAC 274. This ensures that all modules in the storage system 200 are synchronized timestamp, and the SP 210 is further configured to allow a customer to configure a fixed time zone/time on the SP 210 when there is no external NTP server (but, in this case, the SP 210 still serves as the NTP server for the DSP 240 and the SAC 274). The SP 210 preferably supports control path boot up sequencing in which at system boot up, the SP 210 waits for a certain well-defined time interval for the DSP 240 and the SAC 274 control paths 246, 276 to come up to an operational state. If the control path 246, 276 does not become operational within the set time, then the SP 210 generates alerts to the administrator and to support remote monitoring (see element 226).

The SP 210 further serves as the syslog server via function 238 in control path block 220 for DSP 240 and SAC 274 and any associated storage arrays. Both the DSP 210 and SAC 274 redirect their syslogs to the SP 210. The SP 210 uses the syslog functionality 238 to monitor syslogs for necessary alerts and allows administrators to view the syslog for advanced troubleshooting purposes. The SP 210 supports taking firmware core dumps of the DSP 210 and components associated with the SAC 274 and provides the ability to upload such core files to remote service engineers for further analysis and troubleshooting. The SP 210 also supports software distribution with function 230 for the storage system 200. In this manner, tested/qualified software and firmware baselines can be downloaded and installed on each of the modular components 210, 240, 274. The baseline concept ensures that firmware and software image versions installed on the SP 210, the DSP 240, and the SAC 274 as a set are tested and supported.

The SP 210 further supports remote lights out power management to allow for storage system 200 to be remotely powered up and down. The SP 210 acts as the server responsible for assigning IP addresses to control path blocks 246, 276 of the DSP and SAC modules 240, 274. For example, the SP 210 may also act as RARP server or DHCP server for the DSP 240 and the SAC 274 and linked storage arrays. The SP 210 supports adding and removing arrays from the storage system 200. Whenever a new array or other storage device is linked to the SAC 274 via interconnect 281, the SP 210 brings the array to the default settings expected for addition to the system 200. This may require clearing up existing RAID sets and/or LUNs on the array, setting up the SP 210 as NTP server for the array, setting up a syslog file redirection for the SP 210 to act as syslog server, and other initialization steps. The SP 210 also promotes remote connectivity to remote services via one or both of the remote services and the remote monitoring and diagnostics functions 228, 226 to allow remote service engineers to remotely administer the storage system 200.

FIG. 3 illustrates a method of configuring and maintaining a modular data storage system, such as may be performed by operation of system 100 or providing system 200. The process 300 starts at 310 typically by defining the partitioning techniques and processes to be followed to configure modular data storage systems. At 320, the process 300 continues with defining control path and data path function and interfaces that may be provided within a modular storage system. Further, the partitioning to be used is defined and in some cases, the various functions are generated and stored. For example, the storage developer system 160 shown in FIG. 1 includes in memory 170 a set of functions 173 that are partitioned for provision with service processors 172, a set of functions 175 that are partitioned for provision with data services platforms 174, and a set of functions 179 that are partitioned for provision with storage array controllers 178.

As discussed previously, the functionality that may be provided in the data path portion of a modular system by a paired DSP and SAC can vary widely to practice the invention. In many systems, a RAID functionality is defined to provide an availability for disk drive failures and provide performance advantages associated with accessing multiple drive spindles for a host-initiated I/O operation. The RAID functionality may also define operations such as RAID levels, RAID operations during disk drive failures, RAID rebuilds, RAID parity checking, and the like. The data path functionality may also include one or more of the following: end-to-end data integrity (e.g., host to storage), point-in-time snapshot (e.g., copy on write, split mirror, rollback, delta tracking/reporting, and more), remote data mirroring, remote data replication, caching strategies, tape backup, tape emulation, multi-path access, serviceability, performance tuning, HSM features, quality of service (QoS) features, environmental services, topology management functions, framework integration features, data path storage security and other security function, and other functions.

At 330, the various SP, DSP, and SAC configurations are defined explicitly or made implicitly available by providing the menu or set of functions 173, 175, 179 that can be selected from for configuring a SP, DSP, and SAC. In other words, a number of SP configurations can be defined and provided with varying subsets of the functions 173, and likewise, configurations of DSPs and SACs can be defined and provided with varying subsets of the functions 175, 179. In some cases, the configurations are completely interchangeable and any can be used together to generate a modular storage system but in other cases, such as when desired end-to-end implementations are desired, there will be a “pairing” of various modular configurations to ensure the compatibility of the various module configurations.

At 340, the method 300 continues with receiving (such as in a customer request for a storage system) or determining a set of data storage implementation requirements or defining a planned operating environment. In step 340, it is determined what control path and what data path functionalities are required or desired, such as by a customer, for a storage implementation, e.g., is RAID desired, if so what level, is caching required, what virtualization if any is required, what are the RAS requirements, what diagnostic capabilities are required, and the like. In this manner, the data storage functionality to be provided is defined for the planned system.

At 350, based on the retrieved or received data storage implementation, an SP configuration, a DSP configuration, and an SAC configuration are selected for the new modular data storage system. In some cases, this may involve selecting functions 173, 175, 179 for each of the modules (i.e., the SP, DSP, and SAC) to provide at least the control and data path functions required to meet the functionality required for the storage implementation. At 360, a modular storage system is configured and installed using the selected configurations of the modules or selected subsets of available module functions. Each module may be configured separately and then shipped for later connection as a system or the system and components may be installed and then configured with the desired functionalities. After 360, the installed modular data storage system can be operated by the user or customer.

The hardware used to implement the modular components may vary to practice the invention and likely will change over time. However, in one exemplary embodiment, the SAC is implemented in the form of a controller pair connected together by a high performance hardware assisted cache mirroring link. A set of disk drives is connected to both SAC controllers. Under normal operating conditions, the LUNs residing on the shared disk drives are divided into two non-overlapping groups, each being accessible from the DSP through only one of the SAC controllers. When the DSP detects a failure in one of the SAC controllers, it triggers an explicit failover to the surviving controller. After the failover event, all LUNs are accessed through the surviving SAC controller until the failed SAC controller is repaired at which time the DSP may trigger a fail-back action. Each of the two SAC controllers exports two 2 Gb/s FC ports to the DSP. Each of the FC ports are capable of sustaining 40 K IOP/s small IO throughput. A standard 2 Gb/s FC copper cable may be used to connect the ports. The LUNs assigned to a particular SAC controller may be accessed concurrently through any of the two FC ports. When the DSP chooses to trigger an SAC controller failover event, the DSP abandons both of the FC ports on the malfunctioning SAC controller and continues to access LUNs through either of the two ports on the surviving SAC controller. Expansion disk trays, if used, are typically connected to the SAC controllers and not directly to the DSPs. Each of the SAC controllers exports a single 10/100 BaseT Ethernet port to provide the control path connectivity with the SP and DSP. Of course, other hardware embodiments will be apparent to those skilled in the art and are considered within the breadth of this description of the invention and the following claims.

At 370, the process 300 continues with determining whether an update is desired or needed or whether the storage should be modified. This determination may be based on changing needs of the customer or based on newer versions of control or data path functions or interfaces becoming available. If a modification or upgrade is required, the process continues at 380 with determining which modular components need to be modified or replaced to provide the additional functionality or to provide the upgrade to a newer version of a function or interface. At 390, the updates are selected, e.g., new functions 173, 175, 179 may be selected for installation on a module, or one of the components, such as the SP, DSP, or SAC, may be replaced with a selected new module that is configured with the desired set of partitioned control and data path functions. Step 360 is then repeated to either plug in the new module and replace the old or to upgrade the existing module with the new function or functions (or interface(s)).

To further explain certain embodiments and features of the invention, the following descriptions are provided for partitioning within a modular data storage system to achieve desired functionalities. More particularly, the following paragraphs provide partitioning descriptions for RAID functions, caching functions, advanced virtualization, storage multi-path access, snapshot, remote data mirroring services, tape device and backup services management, and tape emulation. Again, these functionalities are only exemplary of those that may be partitioned according to the techniques of the present invention, and it is believed that once these partitioning techniques are understood one skilled in the art would readily be able to apply the techniques to partition other data storage functions within a modular data storage system.

The modular data storage systems of the present invention may include partitioning for Bit Level Data Availability (e.g., RAID). At the system level, the availability of data in the system in the event of failures depends on several things including the type of failure, the impact of failure, and the ability of the system to survive a failure, and RAID partitioning specifically addresses the availability of data in the event of disk drive failures. It has long been established that certain levels of RAID can ensure continued availability of data in the event of disk drive failures. In the some embodiments of the invention, three specific RAID levels, namely RAID 0, RAID 1+0 and RAID 5 are utilized but others could be specified as well.

Regarding hardware, certain RAID operations may involve a lot of movement of data. In those cases, the hardware should ensure adequate memory bus and I/O bus bandwidth. Where the memory and I/O bus bandwidth is a limitation, the XOR operation may need to be performed in-line as the data being transferred to the cache to avoid multiple redundant transfers on the memory and I/O bus. Therefore, it may be a requirement that a hardware accelerated XOR engine or adequate memory and I/O bus bandwidth be present in the storage system. Typically, there needs to be a hot spare disk available for re-build operation to take place when a failure occurs. This requirement may be relaxed when a hot space model is developed. In a hot space model, there is no dedicated spare disk, but all unused and available storage can be used for sparing purposes.

Regarding performance, the RAID-5 configuration should be selected in such a way that when a disk failure occurs the re-build time does not become impractical due to increased vulnerability for data loss due to an additional failure during the re-build process. The performance should not be so impractical that it consumes all the internal cache and disk bandwidth to inhibit the host I/O performance. Therefore, the SAC preferably is configured to ensure that it maintains a good balance between the I/Os initiated by the hosts and all internal I/Os caused due to rebuild or disk scrubbing operations.

With regards to RAS considerations, in RAID configurations, the SAC should be configured to ensure that there is no inconsistency of data when one or more failures occur within SAC. The RAID configurations should be selected in such a way that when a disk failure occurs the re-build time should never become impractical due to increased vulnerability for data loss due to an additional failure during the re-build process. All disk drives connected to the SAC should be hot-replaceable in the event of a failure. The disk drives may develop defects in the disk blocks. Such defects are detected via the medium error reported by the disk drive. When a RAID set has no failed disks and a bad disk block is encountered, the system should compensate for bad blocks by using parity information to re-compute the bad block's original contents, which is then remapped to a “spare” block by the disk drive elsewhere on the disk. However, if a bad block is encountered while the RAID set is in a degraded mode due to failure of another disk drive, then the data belonging to that block's is irrecoverably lost.

To protect against the scenario of loss of data described above, SAC is preferably configured to routinely perform background scrubbing at some well defined intervals. The scrubbing on independent RAID sets may be run in parallel. During this process, all data blocks are read from RAID sets that have no known failed disk drives. If a medium error is detected, the bad block is re-computed and the data is rewritten to a spare block on the same disk. Otherwise, parity is re-computed and verified. If it does not match, then the SAC preferably tries to isolate the error in the raid-set if a data integrity mechanism is in place. If the error turns out to be irrecoverable either due to multiple failures, or lack of data integrity detection and correction, then the SAC reports the error through the management interface to the DSP for corrective action. The corrective action could be replenishing the broken data from a redundant copy such as snapshot, remote copy or another local mirror.

Regarding scalability, the SAC should be adapted to support adequate number of RAID sets. With reference to manageability concerns, in a RAID-5 configuration, when a disk failure occurs, the SAC should ensure that if a spare disk is available, it is automatically used for RAID re-build operation without any manual intervention. In large configurations, the SAC may need to provide mechanisms for automatic creation of default RAID sets.

With reference to the general theory of the RAID feature, in the case of RAID 0, all of N drives are striped with no redundancy information. The RAID 0+1 configuration is a mirrored pair (RAID-1) made from RAID-0 stripe sets. In other words, the RAID 0+1 is created by first creating two RAID-0 sets and adding RAID-1 on top of it. If there is a loss of a disk drive in one half of the mirror of a raid-set, then with another loss of a disk drive in the alternate mirror of the raid-set before the first side is recovered, it then results in loss of data. It is also important to note that in the case of RAID 0+1, all the disk drives in the surviving mirror are involved in re-silvering the entire data stripe set, even if the damage has occurred to only one of the disk drives. The RAID 1+0 configuration is a stripe set made up from N mirrored pairs of disk drives. Only the loss of both the disk drives in the same mirrored pair can result in any loss of data. Further, in terms of probability, the loss of that particular drive is 1/Nth as likely as the loss of some drive on the opposite mirror in a RAID 0+1 configuration. The recovery only involves the replacement disk drive and its mirror, so the rest of the raid-set performs at 100% capacity during recovery. Also since only the single disk drive needs recovery, the bandwidth requirements during recovery are also lower and also the fact that the recovery takes far less time thus reducing the risk of catastrophic loss of data.

The RAID 5 configuration is a stripe set made up from N disk drives with an additional redundancy (called parity information) data stored. The parity data is rotated across all N drives to avoid any hot spots with regard to accessing and updating the parity information. The RAID 5 configuration can only survive a maximum of one disk drive failure. When a disk drive fails, all data is still fully available. The missing data is accessed by calculating it from the data that remains available and from the parity information.

To provide a statement of partitioning, the SAC should ensure that all RAID functionality is provided within it without any external assist or intervention by the DSP. The DSP may employ higher level data migration techniques to evacuate data from one SAC and move it to another SAC but the fundamental RAID functionality is not provided by the DSP. The DSP should provide virtualization services on top of the RAID sets exported by SAC. With reference to SAC and DSP feature interaction, every volume exported from the SAC should make a property available to the DSP about the data availability mechanism provided. This interaction is via the management interface. The DSP may use this information for various purposes.

There are some power on and reset sequencing implications with this partitioning feature. The disk drives upon power up may take several seconds to spin up and during this time, the DSP may not be able to access Logical Units belonging to these disk drives. The SAC should ensure that it provides either a BUSY indication via SCSI status or a SCSI check condition indicating that the Logical Unit is not ready, in response to any commands received from the DSP, and the DSP should retry the commands with a suitable back-off algorithm.

When an error occurs during an I/O operation to the disk drive, it can be classified as either recoverable or fatal. All recoverable errors must be suitably retried and an attempt be made to recover from the error at the SAC level. If a fatal error occurs, the error handler in the SAC must first make an attempt to determine the source of the error, such as whether the error occurred in the interconnect to the disk, or within the controller, or in the disk drive itself. If SAC determines that the error is in the disk, the SAC preferably performs an appropriate RAID level recovery operation such as reading from an alternate mirror or re-generating the data with the help of parity and other drives in the RAID set. Further, the SAC invokes appropriate rebuild operation based on the RAID level. If a fatal error occurs within the controller, such as DMA engine failure, or cache failure, the controller should shut down allowing its partner controller to take over. The SAC also provides error information via the management interface to the DSP to enable the DSP to take appropriate actions.

The SAC has a number of roles in the modular data storage system. In the data path, the SAC provides support for RAID levels RAID 0, RAID 1+0, and RAID 5. No special interfaces between the DSP and the SAC in the data path are required to perform RAID operations in the SAC. The SAC implements RAID scrubbing. In the control path, the SAC exports functions to manage the raid sets to the service processor in the storage system. Because the RAID functionality is partitioned solely within the SAC, the DSP has no responsibilities or functionality requirements for the RAID functions.

The modular data storage system may also be partitioned to provide caching functions. As to the system level description of the caching function, in storage systems, the disk access times can be considerably high. In addition to the physical constraints imposed by the disk access times, the data protection mechanisms used by storage systems such as RAID may cause additional burden. Typically, the applications tend to have buffer caches at the host level, but these hosts may still have limitations with regard to the size, mode of caching, and the like. Nonetheless, when I/O requests are issued, the storage systems are expected to hide the access latency to physical disk drives via caching.

In a cache hierarchy starting at the applications all the way to the storage system, it is often the fact that the storage system's cache is found to be a second level cache with the first level cache being located in the host itself. This poses considerable challenge in the storage system in providing suitable cache algorithms for various operations such as pre-fetch, de-stage, replacement, and the like. For READ I/O requests, the predictability of access patterns is not easy due to the requests being fairly random because the requests received in the storage system are essentially first level cache misses. Still for WRITE requests, the storage system can provide considerable help by placing (effectively terminating the host request) the incoming data in the cache.

In a multi-tiered storage system architecture, the overall utilization of the cache is a challenging problem. This problem is somewhat overcome in monolithic storage system designs with a centralized shared cache approach, although the shared cache could potentially become a bottleneck due to contention. It is important to note that the need for cache is important for both the user data as well as other data such as parity in storage systems. Two traditional approaches to solving this problem in a modular storage system design are: two level caching and dedicated cache in each RAID controller. The following paragraphs describe the design of a modular data storage system with a dedicated cache in each RAID controller that may be provided by partitioning according to the present invention.

Regarding hardware considerations, to be able to provide write-behind caching feature, the storage system preferably provides non-volatile memory for caching of the user data as well as the corresponding meta-data. The hardware should be selected to provide mechanisms to make a mirror of the non-volatile cache in an independent failure domain such as the partner controller in the controller pair. The memory used for cache typically will have error detection and correction capability. The hardware platform may also support memory scrubbing.

As to caching performance considerations, when caching is enabled, the modular data storage system is preferably configured to make attempts to provide effective utilization of cache. The I/O latency and throughput should also be better compared to the scenario of non-existence of cache. As to RAS considerations, in the event of a catastrophic errors such as a storage array controller failure, there should exist a good copy of all un-committed user data and the corresponding meta-data in an independent failure domain for the other controller to secure the data by eventually syncing to disk drives and continue to provide access to the user data. The system also preferably ensures the integrity of the meta-data as well data for all committed I/O operations. The cache subsystem should not be configured to make assumptions such as power-on conditions of all disk drives when a catastrophic error such as power failure occurs. In such an event, the system should provide an emergency cache flush mechanism to a well known secondary storage device. If a controller fails in the SAC in the middle of de-stage or cache flush to the disk drives, the partner controller that eventually takes over from the failed controller should ensure the consistency of data.

As to scalability, the modular data storage system should provide an adequate amount of cache both in size and bandwidth based on the storage capacity and the application needs. Further, the software algorithms for cache management should provide an overall effective utilization of the available cache. As to manageability, the cache subsystem should support statistics such as cache hits, misses, transfer rate, read/write ratios, and the like for management software to utilize. The cache subsystem should also support mechanisms to modify caching policies at the granularity of a logical entity exported by the SAC. The caching policies include modes of caching (write-through, write-behind) and caching parameters such as read-ahead value, de-stage threshold, and the like. The SAC may provide the ability to lock or pin the data blocks in the cache belonging to a certain raid-set or certain range of blocks within a raid-set.

Generally, the theory of operation of caching with the modular data storage system can be states as the organization of cache including meta-data and data in a non-volatile memory. It may not always be practical for the software to directly manipulate the meta-data in the non-volatile memory and in those situations, the software may keep a copy of volatile meta-data for all the lookup and update operations, and at the same time keeping all the committed meta-data in the non-volatile memory. The meta-data and data are mirrored in the partner controller of the controller pair. The software defines the structure of meta-data in the cache and is responsible for the integrity of all committed I/O operations. When write caching is enabled, the data from the application clients is cached in a non-volatile memory in the storage system. When read caching is enabled, the read requests from application clients are serviced by performing the lookup for data in the cache, and if there is a hit, the data is transferred from the cache to the application client.

The cache sub-system is responsible for implementing pre-fetch algorithms in an attempt to reduce the disk access time. The pre-fetching technique performs a background fetch operation of the blocks that are likely to be accessed by the application. There are two fundamental approaches to pre-fetching. The first one is to detect sequentiality based on the block access pattern and perform background fetching. The other approach is to receive explicit hints from the application about pre-fetching as part of the I/O requests. The cache sub-system is responsible for implementing cache replacement algorithms. The important considerations during cache replacement are locality and frequency of access. The cache sub-system should export the cache statistics, cache policies for management function.

As a statement of partitioning for caching, the cache sub-system should be implemented in the SAC with the cache parameters such as modes and policies being controlled by management software. The cache sub-system should export cache parameters, cache statistics, and the like for management on the control path. The DSP may provide cache hints such as pre-fetch and de-stage as part of the I/O requests. The cache sub-system may provide interfaces via the management interface to lock or pin the data blocks in the cache belonging to a certain raid-set or certain range of blocks within a raid-set. Upon power-on, the cache sub-system should first determine if there was any dirty data that needs to be flushed to the disk drives before initializing the cache.

In the cache sub-system, errors could occur under several scenarios such as errors during remote mirroring of cache, meta-data update, de-stage. In addition, there could be un-correctible errors in the cache memory itself as well as in DMA logic while moving data to/from cache. Under all these scenarios, the cache sub-system is responsible for detecting and taking corrective action appropriately. The corrective action may range from retrying the operation to failing the entire controller itself if no recovery is possible.

The role of the SAC includes data path functional responsibilities and control path functionalities. As to the data path, the SAC offers adequate cache both in size and bandwidth proportional to the storage capacity. The SAC is responsible for non-volatile cache, cache meta-data consistency and cache scrubbing. In addition, the SAC mirrors the cache in an independent failure domain such as partner controller. In the control path, the SAC is responsible for setting up cache parameters such and policies. Some of the important cache policies are: Cache Modes; Write-through; Write-behind; De-stage Thresholds; and De-stage algorithm and some of the interesting cache parameters are: Number of Cache Lines; Cache Line Size; and Total Cache Size. The control path of the SAC is responsible for monitoring the system at run-time and setting the cache parameters appropriately. For example, when the battery is low, the control path may set the cache mode to write-through until the battery refresh is complete. The control path of the SAC is also responsible for statistics collection and reporting. Some of the interesting cache statistics include: Number of Free Cache Lines; Length of LRU list; Number of Dirty Cache Lines; Number of Valid Cache Lines; Total number of cache hits; Total number of cache misses; Total bytes read by DSP/Disk; Total bytes written by DSP/Disk; Average read time to DSP/Disk; Average Write time to DSP/Disk; Depth of Hash Buckets (Or Trees); Access Pattern; Temporal Distance (Min Max); and Access Frequency.

In contrast, the role of the DSP is very limited for caching. As to the data path, the DSP may provide hints to SAC cache subsystem during I/O. As to the control path, the DSP control path may gather cache statistics for monitoring the behavior of backend storage for its volumes. In addition, the DSP control path may want to set cache policies and parameters.

Modular data storage system of the present invention may also include partitioning for advanced virtualization. At the system level, advanced virtualization features provide the ability to aggregate and abstract multiple storage devices into a single storage system. Key features include: Striping & Concatenation (Aggregation) of storage devices; Storage devices are typically SACs, disks, tapes, and the like; Dynamic LUN Capacity Expansion; Local Mirroring; Storage System Resource Provisioning; optimal selection of virtual volume composition is provided to maximize storage attributes such as performance, availability, and the like; and Secure Virtual Storage Domains.

Regarding hardware considerations, the storage system hardware preferably provides a platform that allows the efficient processing of data path and control path requests from the host or user. This may be achieved with some or all of the following attributes: (a) State of the art processing of Data Path IO requests and back ground data manipulation tasks (such as data scrubbing, resilvering, parity generation, and the like); (b) High Bandwidth Data Path allowing the storage system to provide bandwidth matching the available SAN technology; (c) User data and control path information data integrity protection provided including data and address bus protection, memory protection, and the like; and (d) Avoidance of active single points of failure in the system as well as the infrastructure to support multiple copies of key data structures and data elements.

Regarding feature performance, the storage system is typically measured in terms of throughput, bandwidth, and (to a lesser extent) latency of data requests. The storage system is measured in terms of their boot up/initialization time as well as time to recover from failure of redundant components. The failure could occur in the SAC, the DSP, or in the interconnects between the SAC and the DSP, or in the interconnects between DSP and customer SAN/hosts. The time for recovery from these failures must be within the boundaries of the retries of host multi-path driver stacks and should avoid failures at application level. It is preferred that the failure recovery times are less than 30 seconds in all, but the worst case scenarios. The storage system should also provide the completion of configuration requests within 5 seconds for all configuration events unless a progress status is provided.

As to RAS considerations, the advanced virtualization features provide an important component to the RAS measure of the storage system. When used, the mirroring feature preferably provides consistent data to the host for all IO requests in which GOOD status is returned to the host through normal completion as well as interruption. In the event of an interruption of IO processing, it is preferred that the mirror be left in an consistent state even if status is not returned to the host for the IO request. Mirroring should be provided with an option to support upto 4-way mirrors (N-way Mirroring [n<5]). The ability to stripe over mirrors is also preferred (RAID 10). The storage system advanced virtualization features should provide the events, alerts and embedded tracing of key system events to allow the debug and repair of storage system problems.

As to scalability, the advanced virtualization features should provide for the scaling of IO requests consistent with the processing, interconnect, and storage resources within the system. This includes the scaling of the number of supported LUNs, storage array controllers, disks, hosts, and the like consistent with the product definition and market intercept point. As to manageability, the advanced virtualization features should be managed through a proper set of CLI, CIM, and GUI presentations to the user and host systems. These interfaces should include the creation, extension, deletion, and tuning of the advanced virtualization features.

Regarding partitioning techniques for advanced virtualization, the DSP provides the advanced virtualization features. Some advanced virtualization features use knowledge of and statistics from the SACs (and possibly tapes) in the storage system. As to SAC and DSP interaction, the DSP is the primary owner of the advanced virtualization features, however, the DSP may query the SAC for attributes associated with the storage device's presented logical units. The DSP may also query the SAC for statistics associated with IO Load patterns seen by the subsystem, cache usage, and the like. Some embodiments of the invention may utilize the ability to ‘pin’ particular cache regions into cache for higher performance related to logs and other metadata used by the DSP for the advanced virtualization features. The DSP is responsible for managing the state of the advanced virtualization features. When state changes of storage devices or the virtualization devices themselves are determined, the proper events, alerts, and errors must be reported.

The role of the SAC in the data path includes the SAC tracking and providing the performance statistics needed for reporting by the SAC control path. Additionally, where data path responsibilities require it, the SAC leverages these statistics. In the control path, the SAC provides the configuration and tuning interfaces consistent with allowing the storage system to properly configure and provision the storage resources of the system. As to the DSP roles, the DSP provides the advanced virtualization features as part of its feature set. The DSP ensures the configuration and data integrity of the storage system volumes through all system points (in many instances >1) of failure and interruptions. In the control path, the DSP manages the configuration of the user volumes during typical configuration sequences as well as during the distribution and redistribution of virtualization objects in the system. In some cases, the advanced virtualization features are separately licensable features. In these cases, the storage system preferably provide the ability to enable or disable features based on this licensing scheme. The DSP control path discovers all connected storage devices and determine their availability to its storage system.

Modular data storage systems of the invention may further include partitioning to provide storage multi-path access. At the system level, the introduction of multi-path storage architectures, particularly RAID Storage Arrays, and host multi-pathing driver architectures has caused a significant amount of work and confusion for array vendors, driver writers, and storage integration teams. This confusion results from the many different multi-pathing models used by various vendors in the industry. These multi-path models use different flavors of symmetric and asymmetric access techniques to manage the redundant ports provided to a host by different storage device vendors. To compound the problems, these multiple models are managed by commands and rules that are unique to each storage device vendor and multi-path driver. This wide assortment of multi-path access models and control mechanisms often limits the choices of the storage device purchaser to very few vendors because of the large investment involved in integrating and managing these devices.

To solve this problem, a modular data storage system can be configured to present storage volumes to the host using a symmetric (equal access through all paths) model requiring no vendor specific commands by the host multi-path driver. This model closely emulates the model presented by a simple multi-ported FC drive. FC drives provide simultaneous access through all paths. Using this model, the underlying storage device presents a volume that can be quickly integrated with host multi-path drivers that view the storage volume as accessed via the asymmetric or symmetric access models. The storage subsystem provides access to the user's virtualized storage through any port configured to access the storage, e.g., assuming the port or host has been configured as accessible through the proper LUN mapping/masking access control lists. The storage subsystem abstracts the asymmetric or symmetric multi-path models provided by the storage arrays using the high-speed internal switching architecture of the DSP.

While the storage system of the present invention provides for great simplification and uniformity in accessing the many complexities of managing storage array multi-path models, the need for host level multi-pathing software may still be present because the multi-pathing software is configured within the host to provide the following functionality. The multi-pathing software identifies the multiple paths to the virtual volumes presented by the DSP and presents these multiple paths as exactly one device to the Operating System. Generally, operating systems do not have the ability to reconcile a single storage device that is discovered through multiple paths. The multi-pathing driver layer provides this reconciliation. The multi-pathing software provides error recovery logic when one of the paths to a storage device fails. When this occurs, the multi-pathing software retries an I/O request that experiences difficulty using an alternate path to the virtual volume presented by the DSP. This recovery software provides fault tolerance in the case of a host bus adapter, cable, switch port, or DSP Fibre Channel/Network Port card failure. In some environments, it is advantageous for the multi-pathing software to provide load balancing across the multiple paths to the DSP. This may be particularly helpful in environments in which the host bus adapter issuing the I/O requests is the bottleneck.

With regard to hardware considerations, the primary requirement is in providing no single point of failure within any of the subsystems in the storage device. As to performance considerations, the primary requirement is in providing low latency failover from a failed component to the connected hosts in a manner that is managed transparently by the host multi-path drivers. For the DSP, this requires path redistribution in the event of a primary path failover as fast as possible. Failover times under most circumstances should be targeted at well under 1 minute whenever possible. For the SAC, this requires that a failover to the other controller for a single or multiple RAID sets is required. As to RAS considerations, the storage system allows the configuration of multiple paths to user volumes for all components in the system from the DSP to the SAC, and to the disk drive JBOD. This provides a high level of availability in the storage system that leverages host multi-path drivers, DSP path management, and disk drive dual port access. It should also be noted that the multi-path management of the data path should be independent of control paths that are used in the storage system, e.g., when possible, a control path failure should not require a data path failover or vice-versa. The storage system should be configured to provide topological views and discovery of the components and paths that the logical storage is mapped to the physical storage.

Regarding scalability, the DSP preferably supports on the order of 2048 to 8192 volumes to be provided to the hosts. DSP failure scenarios typically provide a minimal failover time, with a worst case acceptable failover time of about 4 minutes or the like in addition to the failover time of the underlying SAC. Larger numbers of RAID sets and larger cache sizes should not be allowed to significantly grow the failover time of the SAC. As to manageability, the DSP should be capable of integrating with symmetric and asymmetric models from different host multi-pathing implementations with modest effort. This effort should be primarily focused on error reporting and processing control commands that should largely be no-ops or reporting of appropriate data. The system must provide diagnostics to provide user feedback when configurations are created that do not provide high availability. There should also be notifications whenever any path is lost or restored, even if it is still providing high availability. For example, if a virtual volume is exported over 3 host side ports, and if one path fails, the system is still providing HA connectivity, but there is performance and availability impact. The SAC should provide an explicit, asymmetric failover mode.

Referring to the mode of operation, the DSP provides an abstraction of the SAC multi-path management model providing a symmetric access model using the internal switch fabric of the DSP to provide any ihost connected port to any storage connected port routing of I/O requests through the system. This allows the host connected port to direct I/O Requests to the storage connected (SAC attached) port that provides access to the/an ‘Active’ path to the storage. The storage array controller element of the storage system provides a fully redundant set of access paths to the storage devices. The SAC provides an asymmetric access model through the multiple ports that are connected to the DSP for each RAID set in the system. This model ensures continuous access to the user volumes in the event of any single point of failure including FC Port, FC link, SAC, or drive port failure. “SCSI reserve release” and “PGR” may be supported to allow for 2 node clusters and N node host cluster solutions.

To provide a partitioning statement or description, the general management of multi-path in the storage system is cleanly partitioned between the DSP and the SAC. The DSP is responsible for presenting symmetric access to the host for the volumes that have been mapped to the host for the paths that are provided for that host. The SAC is responsible for presenting an asymmetric path to the DSP that may be managed by the DSP through SAC unique in-line failover mechanisms. The interaction mechanism between the DSP and SAC in one embodiment is managed by the ELF volume failover protocol that is used to place ownership of the SAC RAID sets. The DSP is responsible for managing the retry and erring of the multiple paths to the SAC provided storage. This includes the decision to fail particular paths from the storage connected port to the SAC controller. The DSP is also responsible for the rebalancing of IO processing after data paths have been changed due to a multi-path failover event. During failover operations, the DSP waits a length of time at initialization to ensure that the SAC has had proper opportunity to initialize itself and its RAID sets.

Regarding to the data path role of the SAC, the SAC provides well defined RAID set and LUN access semantics for the volumes and LUNs it makes available to the DSP. This definition can be provided by the T10 SPC and SBC specifications. As to the control path, the SAC provides information on which paths are primary paths and which paths are secondary paths for the RAID sets exported by SAC to DSP. It also provides necessary interfaces to notify about path failures, failovers and provides mechanisms for assigning primary and secondary paths for the RAID sets.

Referring to the DSP data path role, the DSP provides a symmetric access path to the host that emulates the behavior of a disk driver to the host. The DSP provides access to the SAC paths consistent with the access model provided by the SAC. The DSP also manages path access for the following reasons: (a) Controller or FC Link Failure; (b) DSP Storage Processor or Port Failure; and (c) Load Balancing of Volume Definition. As to DSP control path functionality, the DSP provides to the management interface information indicating which paths are in use, and when failovers occur. When failover occurs, the DSP also provides an indication of the reason for the failover.

The modular data storage system may also include partitioning to provide snapshot functionality. Snapshot provides several key features involving the creation of stable Point In Time (PIT) and data update tracking. There are two primary techniques used in creating PIT images. Copy on Write (COW) implementations maintains only the changed data blocks between the original volume and the PIT image. COW snapshot implementations are also called ‘Dependent’ copies because the PIT is dependent on the original volume for data that has not changed since the PIT image was created. Broken Mirror implementations provide a complete copy of the volume data at the time the PIT Image is created. Broken mirror PIT Image implementations are also called ‘Independent’ copies because the PIT image contains a complete set of data at the time of the PIT Image. Once a PIT copy is created, it is also useful to provide Rollback facilities in which the original volume may be restored to the state of the PIT image. Another feature that is useful for some applications (such as ‘incremental backup’) is the reporting of the list of blocks of the original volume that have changed since the PIT Image was created.

Regarding hardware considerations for a modular system, the use of battery backed memory is considered useful as a performance enhancement for maintaining logs and meta data. Useful sizes start in the 128-256 KB range per DSP processor, but larger non-volatile memory sizes would also be useful. This memory should be at a minimum parity protected, with ECC being a better option. Hardware acceleration in the mirroring of this memory would also be helpful for the performance of the snapshot feature since most metadata would need to be mirrored to meet reliability requirements. As to performance, the silvering and re-silvering process should be tunable to ensure control over the impact to normal IO request processing.

As to RAS considerations, the snapshot feature should be configured to recover from all interruptions including loss of power and software crashes without compromising data integrity after recovery. Snapshot should provide availability and data integrity through single points of failure within the system when configured with proper redundancy. It is preferred that a log be kept of all creations, deletions, extensions and state changes for snapped volumes to improve service-ability. Regarding scalability, the system should be constructed in a manner that allows the components of a snapped volume to be distributed across the resources of the storage system. Resources that should be leveraged in this distribution include both DSP (ingress/egress ports, processors, memory, etc.) and SAC (controller processors/memory and spindles) resources. This distribution is the responsibility of the DSP and the Control Path Software. As to manageability, the management of the snapshot feature should include the following attributes through the CIM interface: (a) Ability to create, destroy or refresh a Point In Time Image is required; (b) For Copy-On-Write implementations, the ability to increase the size of the Copy-On-Write log is required; and (c) Ability to group volumes into ‘Consistency Groups’ that allow atomic snapshot actions such as create and refresh.

Regarding a partitioning statement or description, the presentation and implementation of PIT Images and Data Update Lists is entirely the responsibility of the DSP. This includes the management of the Original User Volumes, the COW Logs and MetaData Pages, provisioning of storage devices (RAID sets, disks), and memory based management of in memory structures (either Volatile or Non-Volatile). In some embodiments, consideration is given to snapshot acceleration techniques leveraging the performance or processing attributes available on the SAC. Possibilities include, but not limited to: (a) Pinning Logs in Non-Volatile Memory on the SAC; (b) Maintaining Volume Change Data bit maps at the SAC for Data Update List Management; and (c) Setting of caching strategies for logs and metadata at both the SAC and the DSP based on workload patterns.

There is not significant interaction between the SAC and the DSP for this feature in the near term. In the some embodiments, it may be advantageous to ‘pin’ logs and metadata into the battery backed, mirrored portions of the SAC. Error handling is managed by the snapshot Volume Manager and configuration modules of the DSP. As to the DSP data path functionality, the implementation of the Snapshot Volume Manager handles data path performance and error paths. As to DSP control path functionality, the implementation of the state machines to support snapshot creation, provisioning, state change, modification, and deletion is utilized and is possible for groups of volumes concurrent with one another. Interfaces to the host that allow out-of-band management of the snapshot feature is required to provide mechanisms to create, recreate, and delete Snap Shot Point In Time Images of volumes. Point In Time image volumes must be provided separate LUN mappings and attributes (such as R/W, Read Only, and the like) independent of the original.

In some embodiments, the modular data storage system is configured with partitioning of functions to provide remote data mirroring. Remote Data Mirroring provides the user the ability to mirror data from one location to another location for varying purposes such as business continuance, remote archival, and the like. The remote data mirroring feature provides several site consistency options to provide for varying business requirements. These options provide important performance/recovery time/cost tradeoffs for the customer. These techniques include: (a) Synch Remote Mirroring; (b) Asynch Remote Mirroring; (c) Batched Remote Mirroring; and (d) N-Way Data Replication.

Regarding hardware concerns, the use of battery backed memory is considered useful as a performance enhancement for maintaining logs and meta data for the remote mirroring application. Useful sizes start in the 256 KB range, but larger non-volatile memory sizes would also be useful. This memory should be at a minimum parity protected, with ECC being a better option. Hardware acceleration in the mirroring of this memory would also be helpful for the performance of the snapshot feature since most metadata would need to be mirrored to meet reliability requirements. It is also preferable that the DSP have a minimum of one pair of redundant Ethernet connection for WAN based remote mirroring.

Regarding performance considerations, memory available to the remote mirroring application is related to system performance in that more memory allows more remote mirroring metadata to be available and requires less disk I/O in the processing of remote mirroring metadata. As to RAS considerations, trace logging of communications link and remote mirror volume state transitions should be kept to provide important user and developer feedback for serviceability reasons. Likewise, key performance statistics should be kept and made available to provide performance tuning and trouble shooting feedback. To provide scalability, the DSP provides the ability to scale the number of processors and remote mirror communication ports to provide improved performance when the system topologies support it, e.g., enough external LAN bandwidth available and the like. As to manageability, the management of a remote mirror involves the following: (a) Ability to create/remove remote mirror; (b) Ability to specify remote mirror volume by WWN; (c) Ability to specify creation/deletion of the remote mirror from the user interface from the local site; (d) Ability to specify the attributes of the remote mirror such as asynchronous, synchronous, batch, and N-Way; and (e) Coordination of snapshot images.

As to operations, the remote mirroring implementation is implemented at the DSP using mechanisms that designate processor and I/O connections to providing remote connectivity to a remote DSP. These remote connectivity resources manage the remote mirror communication as well as the attributes specified for the remote mirror behavior for that volume. The remote connectivity resources are then involved with data path I/O depending on the state of the connection to the remote DSP and the current state of coherency of the remote mirror. For optimal mode remote writes, the remote connectivity resources are provided the I/O request and data. The data is then copied based on the remote mirror volume attributes. The remote connectivity resources also participate in the repair of a non-coherent remotely mirrored device. It is important to note that ordering of I/Os is critical in the asynchronous and synchronous mirroring modes of operations. Furthermore, it is required that a set of volumes be grouped into ‘Consistency Groups’ that have the same in order I/O processing requirement on the remote side.

Regarding partitioning, remote data mirroring is entirely the responsibility of the DSP. This includes the management of the Original User Volumes, the tracking of synchronization bit maps & outstanding write logs, provisioning of storage ALUs, and the management of the state of the remote mirror. In some embodiments, considerations are given to remote mirroring techniques leveraging the performance or processing attributes available on the SAC. Possibilities include, but not limited to: (a) Pinning Logs and bit maps into Non-Volatile Memory on the SAC; (b) Maintaining Volume Change Data bit maps at the SAC for Data Update List Management for asynchronous logging; and (c) Setting of caching strategies for logs and metadata at both the SAC and the DSP based on workload patterns.

There is no interaction between the DSP and the SAC for this feature in the near term. In some embodiments, it may be advantageous to ‘pin’ logs and metadata into the battery backed, mirrored portions of the SAC. Error handling is the responsibility of the DSP. Regarding the data path role of the DSP, the DSP provides the performance and error handling management required for the remote mirroring features. As to the control path roles of the DSP, the implementation of the state machines to support remote mirror creation, provisioning, state change, modification, and deletion is required. This should be possible for groups of volumes concurrent with one another. Interfaces to the host that allow out-of-band management of the remote mirror feature is required to provide mechanisms to create, recreate, and delete remote mirror images of local volumes that may coordinated with host activities such as quiescence. Likewise, further integration with snapshot management is also expected.

In another embodiment of the modular data storage system, partitioning is used to provide tape device and backup services management. At the system level, tape device management services provide the management of one or more tape drives as part of the storage system. Backup services management takes the tape management approach a step further to provide a means to backup/archive volumes through backup application hosting on the DSP or through providing Xcopy Support to a backup server. This may include several models including: (a) Pass through Tape Access; (b) NDMP Support; (c) XCopy Support; and (d) Volume Archival.

Regarding performance considerations, high bandwidth data streaming from disk through the SAC to the DSP and to tape device(s) is preferred. The storage system may aggregate SACs and tape devices to improve performance leading to higher bandwidth performance requirements of the storage system. As to RAS considerations, the tape backup management features preferably provide the proper alerts and notifications to indicate system component failures or errors. In addition to the alerts and notifications, the DSP typically is configured to provide statistics consistent with tape backup packages. Tape systems are inherently less robust than disk systems. The storage system preferably provides availability consistent with that of the component devices. As to scalability, it is preferred that the tape backup support for the storage system be allowed to scale as the number of resources in the system committed to the backup/restore function. In the case of Xcopy support or pass through tape command support, the access to the storage system backup must be managed through the LUN mapping and masking interfaces. In the case of NDMP or other backup package support, the tape management feature must be managed through the CLI and CIM interface provided by the storage system. A GUI must also be provided to assist the user in topological determination of system errors. Backups preferably are triggered by one of the following mechanisms: (a) CIM interface at the request of either a user or a host directed script and (b) CLI and GUI interfaces must be added to allow triggers to backup applications.

Regarding partitioning, tape backup is entirely the responsibility of the DSP. This includes the management of the interpreting and forwarding of SCSI tape drive commands, discovery of tape device commands, hosting NDMP Servers, managing volume tape movement, and the management of the states of the backup device and copy. There is no specific interaction between the DSP and the SAC for this feature. The management of errors in an environment using tape devices should be handled carefully due to the streaming nature of the medium. Retries and I/O timeouts must be managed appropriate to the tape device that is being streamed to or streamed from. In the event that a tape command or script fails, it is preferred that the storage system return the proper errors to the requester. When NDMP or archival applications are instantiated within the storage system, the proper notification to the user and critical events will be posted.

Regarding the role of the DSP in the data path, the DSP is responsible for the performance and error path management of I/O requests for backup volumes that are presented. Regarding the role of the DSP in the control path, the implementation of the state machines to support tape backup creation, provisioning, state change, modification, and deletion is required and is possible for groups of volumes concurrent with one another. Interfaces to the host that allow inband or out-of-band management of the tape device is required.

In another embodiment of a modular data storage system, partitioning is used to provide tape emulation. At the system level, tape emulation describes a technique in which the storage system provides backup services that appear as a tape device to a server and application running on the server, but use disk based media for storing the data. This approach provides for better performance and ease of management in providing backup volumes and provides better availability than tape drives due to the potential use of RAID protection of the data that is backed up.

Regarding performance considerations, a key improvement to storage backup strategies provided by tape emulation is the potential performance gains in emulating tape drives with high bandwidth and low cost storage devices such as ATA RAIDs. It is often required that the storage system provide bandwidth to the media consistent with the connectivity medium being used for the host connect. Regarding RAS considerations, the tape emulation feature's RAS attributes of the modular data storage system are preferably consistent with that of the advanced virtualization feature set. The feature preferably provides: (a) the ability to protect the storage from a single point of failure; (b) provide data protection through the storage device data path.

Regarding scalability, the system should be configured to support construction of a set of tape emulation devices to take full advantage of the bandwidth limitations of the storage system resources. As to manageability, the tape emulation interface should provide a user interface that allows the resources to be dedicated to the tape emulation device to be specified through the selection of raw resources or through attribute specification. While operating, the management interface preferably provides key statistics regarding bandwidth and resource utilization.

Regarding partitioning techniques, tape emulation is entirely the responsibility of the DSP, which includes the management of the original user volumes, the presentation of ‘tape devices,’ provisioning of storage ALUs, and the management of the state of the remote mirror. There is no specific new requirements for interaction between the DSP and the SAC for this feature. Fault management is the domain of the DSP. Regarding the data path role of the DSP, the DSP is responsible for the performance and error path management of I/O requests for backup volumes that are presented. As to the control path role of the DSP, the implementation of the state machines to support tape backup creation, provisioning, state change, modification, and deletion is required and should be possible for groups of volumes concurrent with one another. Interfaces to the host that allow inband or out-of-band management of the tape device are preferred.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the layering (e.g., SP, DSP, and SAC) may be logical rather than physical. In the above description, the interconnects between these layers was described as physical interconnects, but in some embodiments, the SP, DSP, and SAC software or applications are run in the same physical chassis. In these embodiments, the same logical partitioning would preferably be maintained to implement the functions performed by each layer, e.g., RAID, caching, snapshots, multi-pathing, replications, and the like and the interconnects would be logical interconnects, e.g., software APIs or the like.

We claim:

1. A modular data storage system with a control path and a data path adapted for managing a storage device and for communicating with a storage management device in the control path and with one or more storage application hosts in the data path, comprising:
a service processor positioned within the control path, the service processor comprising an external management interface interfacing with the storage management device and a control path block comprising a set of control path functions;
a data services platform comprising a host interface interfacing with the one or more storage application hosts, a control path block positioned in the control path linked to the control path block of the service processor and comprising control interfaces, and a data path block positioned in the data path comprising a set of data path functions;
a storage array controller communicatively interconnected with the data services processor, the storage array controller comprising a control path block positioned in the control path linked to the control path block of the service processor and comprising control interfaces, a drive interface interfacing with the storage device, and a data path block positioned in the data path comprising a set of data path functions;
wherein the service processor, the data services platform, and the storage array controller are adapted for independent removal and insertion into the modular data storage system.

2. The system of claim 1, wherein the set of data path functions in the storage array controller comprise functions partitioned within the storage array controller for performance only by the storage array controller.

3. The system of claim 2, wherein the partitioned functions of the storage array controller comprise redundant array of inexpensive disks (RAID) functionalities.

4. The system of claim 2, wherein the partitioned functions of the storage array controller comprise caching functionalities.

5. The system of claim 1, wherein the set of data path functions in the data services platform comprise functions partitioned within the data services platform for performance only by the data services platform.

6. The system of claim 5, wherein the partitioned functions of the data services platform are selected from the group of functionalities consisting of virtualization, backup, snapshots, remote mirroring, hierarchical storage management (HSM), and power management of the data services platform.

7. The system of claim 1, wherein each of the sets of data path functions in the storage array controller and in the data services platform comprise a set of end-to-end functionalities that work in conjunction such that the storage array controller and the data services platform work in conjunction to perform a data path functionality.

8. The system of claim 7, wherein the set of end-to-end functionalities comprise functionalities selected from the group of functions consisting of optimization functions, data integrity functions, reliability serviceability (RAS) functions, and quality of service (QoS) functions.

9. The system of claim 1, wherein the set of control path functions of the service processor comprise a set of management functions partitioned for performance with the modular data storage system only by the service processor and wherein the set of control path functions of the service processor comprise functions selected from the group of functions consisting of user interface functions, remote monitoring functions, diagnostics functions, remote services, software distribution, SNMP interfaces, syslog interfaces, and CIM support.

10. A method for providing a modular data storage system for use with a storage array, comprising:
defining a set of data path functions;
defining a set of control path functions;
defining a set of communication and management interfaces;
partitioning the sets of data path functions, control path functions, and interfaces for performance by a service processor, a data services platform, and a storage array controller;
configuring a service processor component with a subset of the partitioned functions and interfaces for performance by a service processor;
configuring a data services platform component with a subset of the partitioned functions and interfaces for performance by a data services platform;
configuring a storage array controller component with a subset of the partitioned functions and interfaces for performance by a storage array controller; and
interconnecting the configured service processor, data services platform, and storage array controller components to form a modular data storage system.

11. The method of claim 10, wherein the subset of the partitioned functions and interfaces for performance by a storage array controller comprise drive interfaces for interfacing with the storage array and comprise data path functions for performance only by the storage array controller comprising RAID or caching functions.

12. The method of claim 10, wherein the subset of the partitioned functions and interfaces for performance by a data services platform comprise host interfaces for interfacing with a storage application host external to the modular data storage system and comprise data path functions for performance only by the data services platform comprising virtualization, backup, snapshot, remote mirroring, or HSM functions.

13. The method of claim 10, further comprising prior to the configuring of the components of the modular data storage system determining data storage implementation requirements and based on the determined requirements, selecting the subsets of the partitioned functions and interfaces.

14. The method of claim 10, further comprising selecting one of the components of the modular data storage system for modification, providing a replacement data path function, control path function, or interface, and modifying the selected one of the components by configuring the selected one of the components to provide the replacement data path function, control path function, or interface.

15. The method of claim 10, further comprising replacing one of the components of the modular data storage system with a replacement component configured with a replacement subset of the partitioned functions and interfaces differing from the subset of the partitioned functions and interfaces previously used to configure the replaced one of the components.

16. A modular data storage system adapted for managing a storage device, comprising:
a data services platform comprising a host interface interfacing with one or more storage application hosts, a set of control interfaces, and a set of data path functions comprising functions partitioned within the modular data storage system for performance only by the data services platform; and
a storage array controller communicatively interconnected with the data services processor, the storage array controller comprising a set of control interfaces, a drive interface interfacing with a storage array, and a set of data path functions comprising functions partitioned within the modular data storage system for performance only by the storage array controller;
wherein the data services platform and the storage array controller are housed in separate physical devices and are adapted for independent removal and insertion within the modular data storage system.

17. The system of claim 16, wherein the partitioned functions of the storage array controller comprise redundant array of inexpensive disks (RAID) functionalities.

18. The system of claim 17, wherein the partitioned functions of the storage array controller comprise caching functionalities.

19. The system of claim 16, wherein the partitioned functions of the data services platform are selected from the group of functionalities consisting of virtualization, backup, snapshots, remote mirroring, hierarchical storage management (HSM), and power management of the data services platform.

20. The system of claim 1, wherein each of the sets of data path functions in the storage array controller and in the data services platform comprise a set of end-to-end functionalities that work in conjunction such that the storage array controller and the data services platform work in conjunction to perform a data path functionality.

21. The system of claim 20, wherein the set of end-to-end functionalities comprise functionalities selected from the group of functions consisting of optimization functions, data integrity functions, reliability serviceability (RAS) functions, and quality of service (QoS) functions.
